(19) United States
(12) Patent Application Publication
(10) Pub. No.: US 2011/0199858 A1
(43) Pub. Date: Aug. 18, 2011

(54) ESTIMATING INTERNAL MULTIPLES IN SEISMIC DATA

(76) Inventors: Einar Otnes, Houston, TX (US); Shih-Ying Hsu, Houston, TX (US); Adriana Citlali Ramirez-Perez, Houston, TX (US)

(21) Appl. No.: 12/707,266

(22) Filed: Feb. 17, 2010

(51) Int. Cl. G01V 1/00

(52) U.S. Cl. 367/38

(57) ABSTRACT

A method for estimating internal multiples in seismic data. The method includes selecting a subset from a set of regularly sampled seismic data based on a low-discrepancy point set. The method may then include integrating one or more depth integrals of the inverse-scattering internal multiple prediction (ISIMP) algorithm over each data point in the subset. After integrating the depth integrals, the method may then include integrating a function of the integrated depth integrals using a quasi-Monte Carlo (QMC) integration over the subset, thereby generating an estimate of the internal multiples.

### BACKGROUND

1. Field of the Invention

Implementations of various technologies described herein generally relate to seismic data processing.

2. Discussion of the Related Art

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Seismic exploration is widely used to locate and/or survey subterranean geological formations for hydrocarbon deposits. Since many commercially valuable hydrocarbon deposits are located beneath areas of land and bodies of water, various types of land and marine seismic surveys have been developed.

In a typical land or marine seismic survey, seismic receivers are installed in specific locations around an area of the earth in which hydrocarbon deposits may exist. Seismic sources, such as vibrators or air guns, may move across the area and produce acoustic signals, commonly referred to as “shots,” directed down to the earth, where they are reflected from the various subterranean geological formations. Reflected signals are received by the sensors, digitized, and then transmitted to a survey database. The digitized signals are referred to as seismic data. The ultimate aim of this process is to build a representation of the subterranean geological formations beneath the surface of the earth. Analysis of the representation may indicate probable locations of hydrocarbon deposits in the subterranean geological formations.

Seismic data, however, may often include multiples. Multiples refer to seismic energy that has been reflected downwards at least once before it has been received by the seismic receivers. Multiples are typically classified as free-surface multiples or internal multiples. Free-surface multiples include seismic energy that has been reflected downward from the free-surface. In a land seismic survey, the free-surface is the upper surface of the earth. In a marine seismic survey, the free-surface is the surface of the body of water. Internal multiples include seismic energy that has been reflected downward from a reflector below the free-surface before it is received by seismic receivers. All the reflections related to internal multiples occur below the free-surface.

Seismic data are often degraded by the presence of these internal multiples. Internal multiples in the seismic data are caused by the presence of one or more internal multiple generators below the surface (i.e., earth surface or sea floor). An internal multiple generator is a reflector where a downward reflection occurs, thus generating an internal multiple. A reflector is caused by changes in the earth parameters (e.g., density or velocity) of the subterranean structure. The presence of an internal multiple generator between the recording surface and a given reflector (or set of reflectors) causes multiple reflections to occur between the internal multiple generator and the reflector(s). Thus, for example, a seismic wave that travels downwardly into the subterranean structure will have a portion that is reflected back from the internal multiple generator, and have another portion that passes through the internal multiple generator to a reflector. A seismic wave is then reflected from the reflector back up towards a recording surface where the seismic receivers are located. A portion of this reflected seismic wave travels through the internal multiple generator to the recording surface. However, another portion of this reflected seismic wave is reflected back down by the internal multiple generator towards the reflector, which is then followed by further reflection from the reflector up towards the recording surface. Such reflections between the internal multiple generator and reflector can occur multiple times. Seismic data received after these reflections are referred to as internal multiples. The presence of internal multiples in the recorded seismic data pollutes the recorded seismic data and leads to decreased accuracy in surveying a subterranean structure.

### SUMMARY

Described herein are implementations of various technologies for estimating internal multiples in seismic data. In one implementation, a method for estimating internal multiples in seismic data may include selecting a subset from a set of regularly sampled seismic data based on a low-discrepancy point set. The method may then include integrating one or more depth integrals of the inverse-scattering internal multiple prediction (ISIMP) algorithm over each data point in the subset. After integrating the depth integrals, the method may include integrating a function of the integrated depth integrals using a quasi-Monte Carlo (QMC) integration over the subset, thereby generating an estimate of the internal multiples.

In another implementation, the method for estimating internal multiples in seismic data may include generating a set of regularly sampled seismic data from the seismic data and generating a low-discrepancy point set from the set of regularly sampled seismic data. Next, the method may include selecting a subset of the set of regularly sampled seismic data based on the low-discrepancy point set and integrating one or more depth integrals of the ISIMP algorithm over each data point in the subset. The method may then include creating a function of the integrated depth integrals based on one or more horizontal wavenumber integrals of the ISIMP algorithm. After creating the function of the integrated depth integrals, the method may integrate the function using a QMC integration over the subset to generate an estimate of the internal multiples.

In yet another implementation, the method for estimating internal multiples in seismic data may include generating a set of regularly sampled seismic data from the seismic data and selecting a subset from the set of regularly sampled seismic data based on a low-discrepancy point set. Next, the method may include integrating one or more depth integrals of the ISIMP algorithm over each data point in the set of regularly sampled seismic data. After integrating the depth integrals, the method may include integrating a function of the integrated depth integrals using a QMC integration over the subset, thereby generating an estimate of the internal multiples. Next, the method may include removing the estimate of internal multiples from the seismic data.

The claimed subject matter is not limited to implementations that solve any or all of the noted disadvantages. Further, the summary section is provided to introduce a selection of concepts in a simplified form that are further described below in the detailed description section. The summary section is not intended to identify key features or essential features of the claimed subject matter, nor is it intended to be used to limit the scope of the claimed subject matter.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates a schematic diagram of marine seismic survey in accordance with implementations of various techniques described herein.

FIG. 2 illustrates a flow diagram of a method for estimating internal multiples in seismic data in accordance with implementations of various techniques described herein.

FIG. 3 illustrates a flow diagram of a method for preprocessing acquired seismic data in accordance with implementations of various techniques described herein.

FIG. 4 illustrates a flow diagram of a method for converting estimated internal multiples to the time-space domain in accordance with implementations of various techniques described herein.

FIG. 5 illustrates a schematic diagram of a set of regularly sampled data in accordance with one or more implementations of various techniques described herein.

FIG. 6 illustrates a schematic diagram of a set of Hammersley points generated based on a domain of a set of regularly sampled data in accordance with one or more implementations of various techniques described herein.

FIG. 7 illustrates a schematic diagram indicating which data point in a set of regularly sampled data is closest to a Hammersley point in a set of Hammersley points in accordance with one or more implementations of various techniques described herein.

FIG. 8 illustrates a schematic diagram of a subset of a set of regularly sampled data based on a set of Hammersley points in accordance with one or more implementations of various techniques described herein.

FIG. 9 illustrates a computer network into which implementations of various technologies described herein may be implemented.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

The following paragraphs provide a brief description of one or more implementations of various technologies and techniques directed at estimating internal multiples in seismic data. In one implementation, a method for estimating internal multiples may be performed by a computer application. Initially, the computer application may preprocess acquired seismic data to remove free-surface multiples from the acquired seismic data. The computer application may then preprocess the resulting seismic data (i.e., without free-surface multiples) to create a set of regularly sampled data in the frequency-wavenumber-pseudo-depth domain. In one implementation, the set of regularly sampled data may consist of co-located seismic sources and receivers that are evenly spaced around the seismic survey area.

In order to create the set of regularly sampled data in the frequency-wavenumber-pseudo-depth domain, the computer application may first interpolate the acquired seismic data such that the sources and receivers are co-located at regular intervals. The computer application may then perform various Fourier transforms to convert the acquired seismic data from the time-space domain into the frequency-wavenumber domain. The computer application may then scale the seismic data and apply an uncollapsed Stolt migration, i.e. a constant velocity migration, to the seismic data to convert the seismic data from the frequency-wavenumber domain to the frequency-wavenumber-pseudo-depth domain.

After creating the set of regularly sampled data in the frequency-wavenumber-pseudo-depth domain, the computer application may generate a low-discrepancy point set for two horizontal wavenumber variables based on the set of regularly sampled data. In one implementation, the low discrepancy point set is a set of Hammersley points. The computer application may then identify a subset of the set of regularly sampled data based on the low-discrepancy point set. In one implementation, each data point in the subset of the set of regularly sampled data may be the data point closest to a point in the low-discrepancy point set.

After identifying the subset of the set of regularly sampled data, the computer application may solve the depth integrals in the inverse-scattering internal multiple prediction (ISIMP) algorithm by integrating the depth integrals over each data point in the subset of the set of regular sampled data. The solved depth integrals may then be combined with the horizontal wavenumber integrals of the ISIMP algorithm to form an internal multiple estimate equation.

The internal multiple estimate equation may include a function of the solved depth integrals based on the horizontal wavenumber integrals of the ISIMP algorithm. The computer application may then solve the internal multiple estimate equation using a quasi-Monte Carlo (QMC) integration over the subset of the regularly sampled data to create a dataset of estimated internal multiples. The dataset of estimated internal multiples may then be converted to the time-space domain by down-scaling the dataset and by performing various inverse Fourier transforms on the dataset.

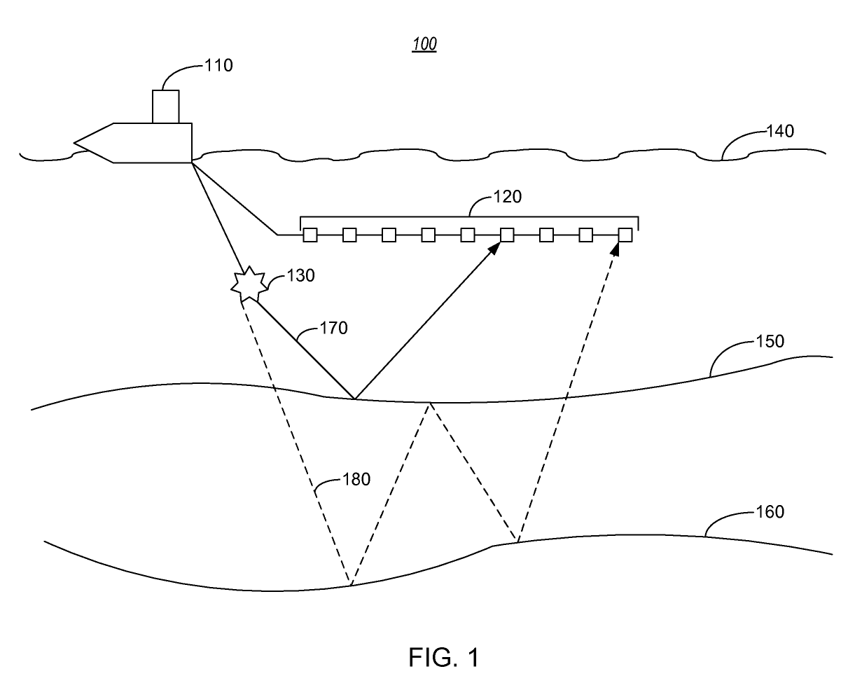

Various techniques for estimating internal multiples in seismic data will now be described in more detail with reference to FIGS. 1-9 in the following paragraphs.

FIG. 1 illustrates a schematic diagram of marine seismic survey 100 in accordance with implementations of various techniques described herein. The marine seismic survey 100 includes a vessel 110, seismic receivers 120 and a seismic source 130. The vessel 110 may float on the free-surface 140. As mentioned above, the free-surface 140 in marine seismic survey 100 may be the surface of the body of water such as the sea. The seismic receivers 120 and the seismic source 130 may be attached to the vessel 110 and disposed under the free-surface 140. Although the seismic receivers 120 and the seismic source 130 are described as being disposed under the free-surface 140, in other implementations the seismic receivers 120 and the seismic source 130 may be floating on the free-surface 140.

Marine seismic survey 100 may include reflector 150 and reflector 160 below free-surface 140 such that the reflectors indicate where different sedimentary layers of the subterranean structure of the earth exist. Different sedimentary layers of the subterranean structure typically have different density and velocity values. In one implementation, the changes between the density and velocity values in the sedimentary layers of the subterranean structure may produce internal multiples in the seismic data acquired by seismic receivers 120. For instance, path 170 illustrates how seismic energy emitted from seismic source 130 may be reflected off of reflector 150 and projected towards the seismic receivers 120. In this manner, path 170 is not an internal multiple. However, path 180 illustrates how seismic energy emitted from seismic source 130 may penetrate through the reflector 150, reflect off of reflector 160 and project towards the seismic receivers 120. The seismic energy reflected off of reflector 160 may reflect off of reflector 150 and reflector 160 again before it travels back to seismic receivers 120. Since path 180 includes seismic energy that has been reflected downward from a reflector below the free-surface before it is received by seismic receivers 120, path 180 is an example of an internal multiple. Although only two reflectors, nine seismic receivers and one seismic source are illustrated in marine seismic survey 100, it should be noted that marine seismic survey 100 may include any number of reflectors, seismic receivers and seismic sources. Further, although FIG. 1 illustrates a marine seismic survey area, it should be understood that the methods for estimating internal multiples in seismic data described herein may be used to estimate internal multiples in land based seismic surveys as well.

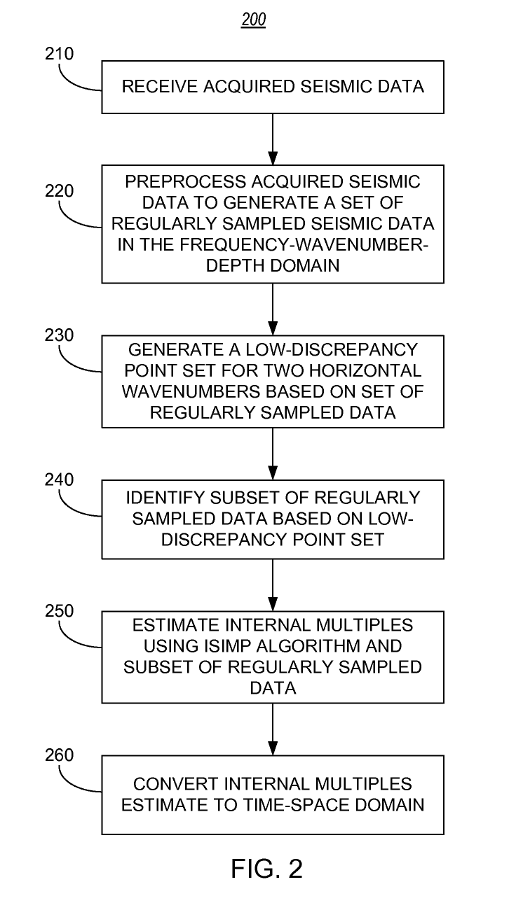

FIG. 2 illustrates a flow diagram of a method 200 for estimating internal multiples in seismic data in accordance with implementations of various techniques described herein. In one implementation, the method for estimating internal multiples may be performed by a computer application. It should be understood that while the flow diagram indicates a particular order of execution of the operations, in some implementations, certain portions of the operations might be executed in a different order.

At step 210, the computer application may receive acquired seismic data. The acquired seismic data may have been obtained from one or more seismic receivers in a seismic survey area. The acquired seismic data may represent the various properties of subterranean formations in the earth. In one implementation, the acquired seismic data may be in the time-space domain.

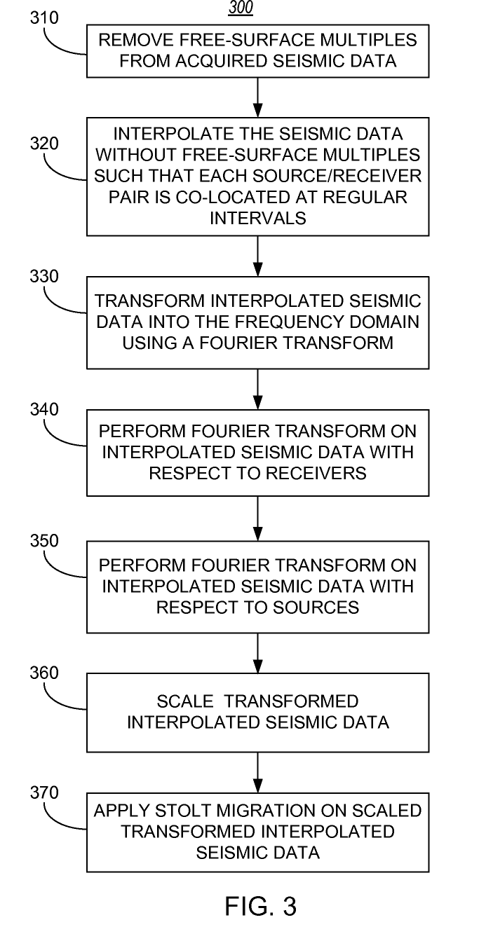

At step 220, the computer application may preprocess the acquired seismic data and generate a set of regularly sampled seismic data. (See FIG. 3). In one implementation, in order to preprocess the acquired seismic data the computer application may first remove the free-surface multiples from the acquired seismic data. (See step 310). As a result, the computer application may output seismic data without free-surface multiples.

The computer application may then interpolate the seismic data without free-surface multiples such that each source/receiver pair is co-located at regular intervals. (See step 320). In one implementation, the interpolated data may be represented as:

D(x_{g}|xₛ; t)

where x_{g} represents a receiver, xₛ represents a source, and t represents time.

The computer application may then perform a series of transformations such that the interpolated seismic data may be transformed from the time-space domain to the frequency-wavenumber domain. In one implementation, the interpolated seismic data may first be transformed into the frequency domain using a Fourier transform. (See step 330). For example, when transforming the interpolated seismic data from the time domain to the frequency domain, the computer application may perform a Fourier transform on the interpolated seismic data in the time domain to obtain the interpolated seismic data in the frequency domain. The interpolated seismic data in the frequency domain may be represented as:

D(x_{g}|xₛ; ω)

where x_{g} represents a receiver, xₛ represents a source, and ω represents angular frequency.

The computer application may then transform the interpolated data from the spatial domain to the wavenumber domain. In one implementation, the wavenumbers in the frequency-wavenumber domain are associated with the sources and receivers. At step 340, the computer application may then transform the interpolated data from the spatial domain to the wavenumber domain by performing a Fourier transform on the interpolated data in the spatial domain with respect to the receivers such that:

D (k_{g}|xₛ; ω)

where k_{g} represents the Fourier conjugate variable (or wavenumber) associated with the receivers.

At step 350, the computer application may then perform a Fourier transform on the interpolated data in the spatial domain with respect to the sources such that:

D(k_{g}|kₛ; ω)

where kₛ represents the Fourier conjugate variable (or wavenumber) associated with the sources. Although the above process for transforming the interpolated seismic data from the time-space domain to the frequency-wavenumber domain has been described in a particular order, it should be noted that the computer application may perform the Fourier transforms described above in any order to obtain the interpolated seismic data in the frequency-wavenumber domain.

After obtaining the interpolated seismic data in the frequency-wavenumber domain, at step 360, the computer application may then scale the interpolated seismic data in the frequency-wavenumber domain using an obliquity factor, i.e., −2iqₛ, such that:

−2iqₛD(k_{g}|kₛ; ω)=b₁(k_{g}|kₛ; ω)

where i is the imaginary unit, qₛ represents a vertical wavenumber associated with the sources where

$${q}_{s} = sgn ( ω ) \sqrt{\frac{{ω}^{2}}{{c}^{2}} - {k}_{s}^{2}} ,$$

and c is the constant background velocity.

At step 370, the computer application may then apply a constant velocity uncollapsed Stolt migration (e.g., water velocity 1500 m/s) to the scaled interpolated seismic data in the frequency-wavenumber domain to obtain the interpolated seismic data in the frequency-wavenumber-depth domain such that:

b₁(k_{g}|kₛ; z)

where z is the depth. The depth in the frequency-wavenumber-depth domain, however, is not true depth since the computer application may only use a constant velocity to transform the interpolated seismic data from time to depth. As such, the frequency-wavenumber-depth domain may also be referred to as the frequency-wavenumber-pseudo-depth domain.

In one implementation, the input to the Stolt migration is b₁(k_{g}|kₛ; ω) which can be interpreted as seismic data in the b₁(k_{g}|kₛ; qₛ+q_{g}) domain using the relationships between the vertical wavenumbers, qₛ and q_{g}, and the temporal frequency, ω. The input seismic data are regularly sampled in the temporal frequency domain. However, the vertical wavenumber associated with the receivers

$$( i . e . , {q}_{g} = sgn ( ω ) \sqrt{\frac{{ω}^{2}}{{c}^{2}} - {k}_{g}^{2}} )$$

and the sources

$$( i . e . , {q}_{s} = sgn ( ω ) \sqrt{\frac{{ω}^{2}}{{c}^{2}} - {k}_{s}^{2}} )$$

will cause the input seismic data to be irregularly sampled in the b₁(k_{g}|kₛ; qₛ+q_{g}) domain. Stolt migration may then be used to interpolate data in the b₁(k_{g}|kₛ; qₛ+q_{g}) domain to a regularly sampled dataset in the same domain. The Stolt migration then transforms the input seismic data to depth by applying an inverse transform from qₛ+q_{g} to the pseudo-depth, z, to obtain b₁(k_{g}|kₛ; z). The concept of uncollapsed Stolt migration is described in “An Inverse-scattering Series Method for Attenuating Multiples in Seismic Reflection Data.” (See Weglein et al., Geophysics 62(6):1975-1989, 1997).

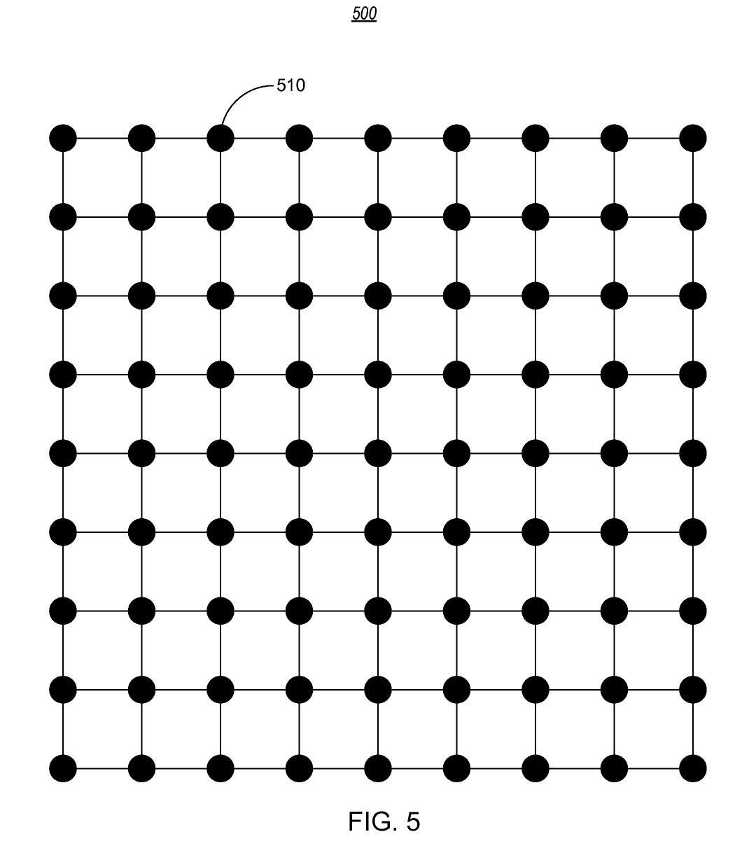

As a result of applying the constant velocity uncollapsed Stolt migration to the scaled interpolated seismic data in the frequency-wavenumber, the interpolated seismic data are represented in the frequency-wavenumber-pseudo-depth domain. In one implementation, the interpolated seismic data in the frequency-wavenumber-pseudo-depth domain may be a set of regularly sampled (i.e., evenly spaced) seismic data in the frequency-wavenumber-pseudo-depth domain having co-located receivers and sources. FIG. 5 illustrates a set of regularly sampled seismic data in the wavenumber domain 500. As shown in FIG. 5, the evenly spaced data points 510 indicate locations where the horizontal wavenumbers associated with the sources and receivers are co-located.

Referring back to FIG. 2, at step 230, the computer application may generate a low-discrepancy point set based on two horizontal wavenumber variables associated with the sources and receivers based on the set of regularly sampled seismic data 500. In general, the low-discrepancy point set may be generated by a deterministic formula. The deterministic formula may identify each point in the low-discrepancy point set such that each point is maximally avoiding each other point within a multi-dimensional hypercube. In other words, if given the same number of points as the set of regularly sampled seismic data 500, the low-discrepancy point set may fill the space represented by the set of regularly sampled seismic data 500 more uniformly and quickly as compared to the data points in the set of regularly sampled seismic data. In one implementation, the low-discrepancy point set may be used to represent the set of regularly sampled seismic data 500 using a fewer number of data points thereby reducing the number of samples needed to evaluate integrals in the ISIMP algorithm efficiently. The low-discrepancy point set may include Hammersley points, Halton points, Sobol sequences and the like. For purposes of discussing method 200 herein, the remaining steps of method 200 will be described using a set of Hammersley points as the low-discrepancy point set. However, it should be understood that method 200 is not limited to using a set of Hammersley points as the low-discrepancy point set; instead, in other implementations any low-discrepancy point set may be used at step 230. Hammersley points techniques are further described in “Sampling with Hammersley and Halton Points.” (See Wong et al., Journal of Graphics Tools, pp 9-24, 1997). Additional details pertaining to how the set of Hammersley points will be used to efficiently evaluate integrals in the ISIMP algorithm will be described in the paragraphs below.

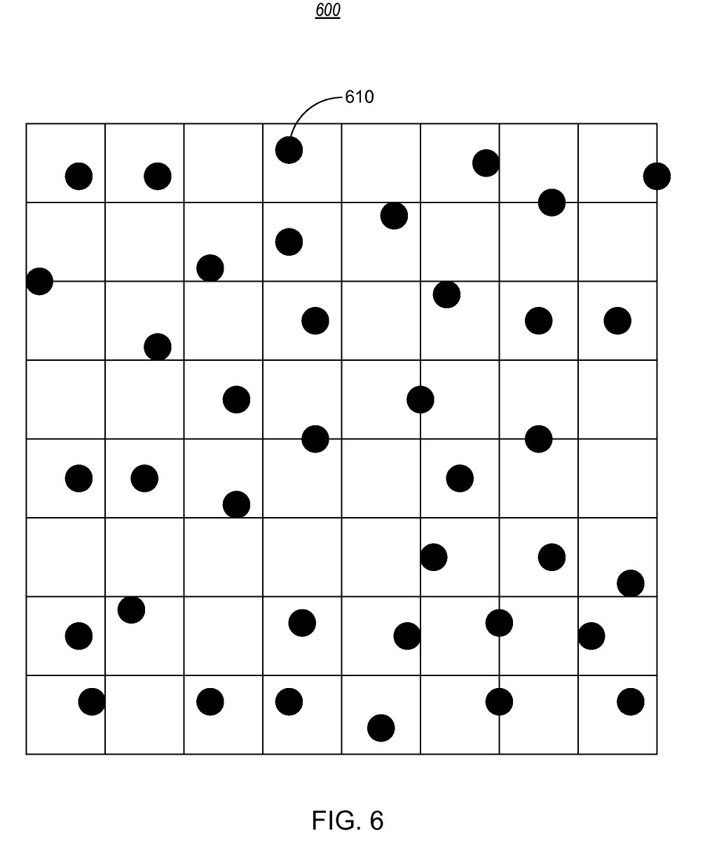

FIG. 6 illustrates a set of Hammersley points 600 generated based on a domain of the regularly sampled seismic data illustrated in FIG. 5. As shown in FIG. 6, the Hammersley points 610 may not correspond with the data points 510 in FIG. 5 because seismic data are not typically measured at the actual Hammersley points. As such, the computer application may identify a subset of data points from the set of regularly sampled seismic data 500 that correspond to the set of Hammersley points 600.

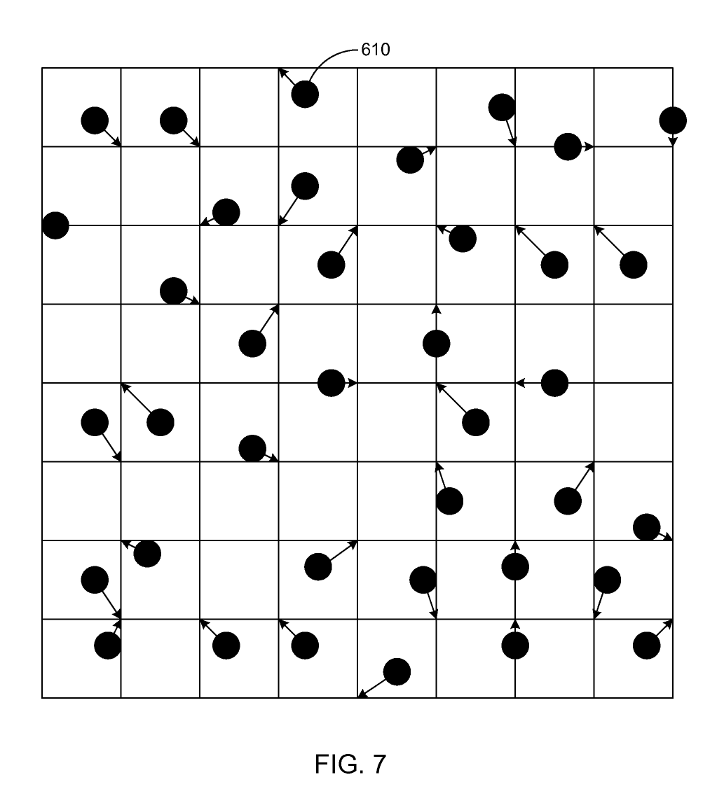

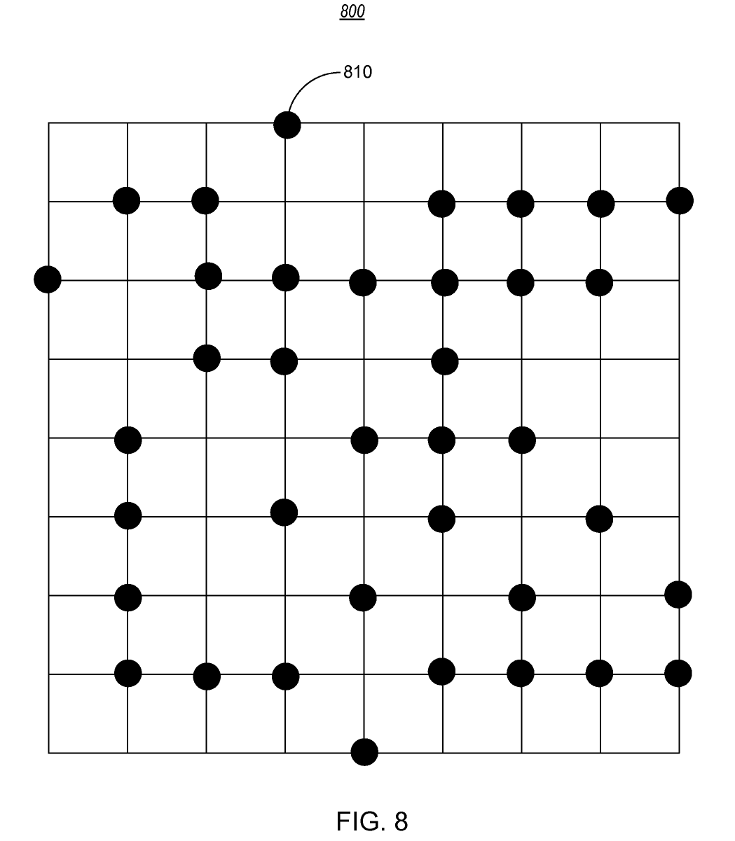

At step 240, the computer application may identify the subset of the set of regularly sampled seismic data based on the set of Hammersley points 600. Each data point in the subset of the set of regularly sampled seismic data may be identified based on its proximity to a Hammersley point 610. For instance, the computer application may identify each data point 510 in the subset of the set of regularly sampled seismic data 500 by determining which data point 510 in the set of regularly sampled seismic data 500 is closest to a particular Hammersley point 610 in the set of Hammersley points 600. After identifying the data point 510 that is closest to the particular Hammersley point 610, the computer application may store the data point 510 as a data point 810 in the subset of the set of regularly sampled seismic data. (See FIG. 8). The computer application may repeat this process for each Hammersley point 610 in the set of Hammersley points 600. This process is illustrated in FIG. 7.

FIG. 7 includes the Hammersley points 610 and an arrow from each Hammersley point 610 that indicates the location of the closest data point 510 to the respective Hammersley point 610. After identifying a data point 510 for each Hammersley point 610, the computer application may obtain the subset of the set of regularly sampled seismic data 800, as illustrated in FIG. 8. FIG. 8 illustrates the subset of the set of regularly sampled seismic data 800 based on the set of Hammersley points 600 illustrated in FIG. 6 and the set of regularly sampled seismic data 500 illustrated in FIG. 5.

At step 250, the computer application may estimate the internal multiples using the inverse-scattering internal multiple prediction (ISIMP) algorithm and the subset of the set of regularly sampled seismic data 800. The ISIMP algorithm is further described in International Patent Application Publication No. WO 95/10787 (Weglein, 1995). The ISIMP algorithm (Equation 1 in 2D and Equation 2 in 3D) involves computing a 5 or 7 dimensional integral over a 2D or 3D dataset, respectively. The computational costs related to utilizing the ISIMP algorithm in a conventional manner are substantial. As such, using the ISIMP algorithm to estimate internal multiples for 3D datasets or a large 2D datasets are currently impractical due to the amount of time and computational costs associated with using the ISIMP algorithm for 3D datasets or a large 2D datasets.

The mathematical formula for the ISIMP algorithm for a 2D dataset is given by:

$${b}_{3} ( {k}_{g} \vert {k}_{s} ; ω ) = \frac{1}{2 π} \int {\int }_{- ∞}^{∞} d {k}_{1} d {k}_{2} {e}^{- i {q}_{1} ( {z}_{g} - {z}_{s} )} {e}^{i {q}_{z} ( {z}_{g} - {z}_{s} )} \times {\int }_{- ∞}^{∞} d {z}_{1} {b}_{1} ( {k}_{g} \vert - {k}_{1} ; {z}_{1} ) {e}^{i ( {q}_{g} + {q}_{1} ) {z}_{1}} \times {\int }_{- ∞}^{∞} d {z}_{2} {b}_{1} ( {k}_{1} \vert - {k}_{2} ; {z}_{2} ) {e}^{- i ( {q}_{1} + {q}_{2} ) {z}_{2}} \times {\int }_{{z}_{2} + ɛ}^{∞} d {z}_{3} {b}_{1} ( {k}_{2} \vert - {k}_{s} ; {z}_{3} ) {e}^{i ( {q}_{2} + {q}_{s} ) {z}_{3}} \\ where \\ {q}_{g} = sgn ( ω ) \sqrt{\frac{{ω}^{2}}{{c}^{2}} - {k}_{g}^{2}} ; \\ {q}_{s} = sgn ( ω ) \sqrt{\frac{{ω}^{2}}{{c}^{2}} - {k}_{s}^{2}} \\ {q}_{1} = sgn ( ω ) \sqrt{\frac{{ω}^{2}}{{c}^{2}} - {k}_{1}^{2}} ; \\ {q}_{2} = sgn ( ω ) \sqrt{\frac{{ω}^{2}}{{c}^{2}} - {k}_{2}^{2}} \qquad ( Equation 1 )$$

The mathematical formula for the ISIMP algorithm for a 3D dataset is given by:

$${b}_{3} ( {k}_{gx} , {k}_{gy} \vert {k}_{sx} , {k}_{sy} ; ω ) = \frac{1}{{( 2 π )}^{2}} {\int }_{- ∞}^{∞} d {k}_{1 x} {\int }_{- ∞}^{∞} d {k}_{1 y} {e}^{- i {q}_{1} ( {z}_{g} - {z}_{s} )} {\int }_{- ∞}^{∞} d {k}_{2 x} {\int }_{- ∞}^{∞} d {k}_{2 y} {e}^{i {q}_{2} ( {z}_{g} - {z}_{s} )} \times {\int }_{- ∞}^{∞} d {z}_{1} {b}_{1} ( {k}_{gx} , {k}_{gy} \vert - {k}_{1 x} , - {k}_{1 y} ; {z}_{1} ) {e}^{i ( {q}_{g} + {q}_{1} ) {z}_{1}} \times {\int }_{- ∞}^{∞} d {z}_{2} {b}_{1} ( {k}_{1 x} , {k}_{1 y} \vert - {k}_{2 x} , - {k}_{2 y} ; {z}_{2} ) {e}^{- i ( {q}_{1} + {q}_{2} ) {z}_{2}} \times {\int }_{{z}_{2} + ɛ}^{∞} d {z}_{3} {b}_{1} ( {k}_{2 x} , {k}_{2 y} \vert - {k}_{sx} , - {k}_{sy} ; {z}_{3} ) {e}^{i ( {q}_{2} + {q}_{s} ) {z}_{3}} \\ where \\ {q}_{g} = sgn ( ω ) \sqrt{\frac{{ω}^{2}}{{c}^{2}} - {k}_{gx}^{2} - {k}_{gy}^{2}} ; \\ {q}_{s} = sgn ( ω ) \sqrt{\frac{{ω}^{2}}{{c}^{2}} - {k}_{sx}^{2} - {k}_{sy}^{2}} \\ {q}_{1} = sgn ( ω ) \sqrt{\frac{{ω}^{2}}{{c}^{2}} - {k}_{1 x}^{2} - {k}_{1 y}^{2}} ; \\ {q}_{2} = sgn ( ω ) \sqrt{\frac{{ω}^{2}}{{c}^{2}} - {k}_{2 x}^{2} - {k}_{2 y}^{2}} \qquad ( Equation 2 )$$

The ISIMP algorithm includes variables denoted with k, which represent horizontal wavenumbers and z, which represents pseudo-depths. The horizontal wavenumbers are Fourier conjugate variables to the spatial receiver and source coordinates. The corresponding vertical wavenumbers are given by q_{g}, qₛ, q₁ and q₂, as described above. The source and receiver depths are given by zₛ and z_{g}, respectively. Given that the ISIMP algorithm includes horizontal wavenumbers and pseudo-depths, the ISIMP algorithm is described as having horizontal wavenumber integrals (i.e., ∫∫_{-∞}^{∞}dk₁dk₂ e^{-iq}^{₁}^{(z}^{_{g}}^{-z}^{ₛ}⁾e^{iq}^{₂}^{(z}^{_{g}}^{-z}^{ₛ}⁾, ∫_{-∞}^{∞}dk₁ₓ ∫_{-∞}^{∞}dk_{1y}e^{-iq}^{₁}^{(z}^{_{g}}^{-z}^{ₛ}⁾∫_{-∞}^{∞}dk₂ₓ∫_{-∞}^{∞}dk_{2y}e^{iq}^{₂}^{(z}^{_{g}}^{-z}^{ₛ}⁾) and depth integrals (i.e., ∫_{-∞}^{∞}dz₁b₁(k_{g}|−k₁; z₁)e^{i(q}^{_{g}}^{+q}^{₁})z^{₁}, ∫_{-∞}^{z}^{₁}^{-ε}dz₂b₁(k₁|−k₂; z₂)e^{-i(q}^{₁}^{+q}^{₂})z₂, ∫_{z}_{₂}_{+ε}^{∞}dz₃b₁(k₂|−kₛ; z₃)e^{i(q}^{_{g}}^{+q}^{₁}^{)z}^{₁}, ∫_{-∞}^{z}^{₁}^{-ε}dz₂b₁(k₁ₓ, k_{1y}|−k₂ₓ, −k_{2y}; z₂)e^{-i(q}^{₁}^{+q}₂)z^{₂}, and ∫_{z}_{₂}_{+ε}^{∞}dz₃b₁(k₂ₓ, k_{2y}|−kₛₓ, −k_{sy}; z₃)e^{i(q}^{₂}^{+q}^{ₛ})z^{₃}).

For purposes of discussing method 200 herein, the remaining steps of method 200 will be described using the mathematical formula for the ISIMP algorithm for a 2D dataset (i.e., Equation 1). However, it should be understood that all of the steps of method 200 described below using Equation 1 for 2D datasets may also be performed using Equation 2 for 3D datasets.

Referring back to step 250, in order to estimate the internal multiples using the ISIMP algorithm and the subset of the set of regularly sampled seismic data 800, the computer application may first solve the depth integrals of the ISIMP algorithm by integrating the depth integrals over each data point 810 in the subset of the set of regular sampled seismic data 800. In one implementation, the subset of the set of regular sampled seismic data 800 is in the horizontal wavenumber domain only. As such, for each horizontal wavenumber, the depth domain is regularly sampled and complete, and the computer application may therefore solve the regularly sampled depth integrals using any conventional integration method. The number of operations required to evaluate the horizontal wavenumber integrals corresponds to the frequency of the output trace, b₃(k_{g}|kₛ; ω), and the number of operations increases nonlinearly as the maximum output frequency w increases. As such, the number of evaluations over the horizontal wavenumbers required to solve the horizontal integrals with respect to their integration limits may make the horizontal integrals too computationally expensive to evaluate using conventional integration methods. In another implementation, since the depth integrals do not depend on horizontal wavenumbers and since solving depth integrals may not be computationally expensive, these integrals may also be solved by using any conventional integration method over each data point 510 in the set of regularly sampled seismic data 500.

After solving the depth integrals, the computer application may then create a function of the integrated depth integrals based on the horizontal wavenumber integrals of the ISIMP algorithm and form an internal multiple estimate equation. In one implementation, the internal multiple estimate equation may be defined as:

$${b}_{3} ( {k}_{g} \vert {k}_{s} ; ω ) = \int {\int }_{- ∞}^{∞} ρ ( {k}_{1} , {k}_{2} , {k}_{g} , {k}_{s} ; ω ) {e}^{- i {q}_{1} ( {z}_{g} - {z}_{s} )} {e}^{i {q}_{2} ( {z}_{g} - {z}_{s} )} d {k}_{1} d {k}_{2} \qquad ( Equation 3 )$$

where ρ is the solved depth integrals of the ISIMP algorithm with respect to the regular sampled seismic data and ρ(k₁, k₂, k_{g}, kₛ; ω) is the function of the integrated depth integrals based on one or more horizontal wavenumber integrals of the ISIMP algorithm where:

ρ(k₁, k₂, k_{g}, kₛ; ω)=∫_{-∞}^{∞}dz₁∫_{-∞}^{z}^{₁}^{-ε}dz₂∫_{z}_{₂}_{+ε}^{∞}dz₃b₁(k_{g}|−k₁; z₁)·b₁(k₁|−k₂; z₂)·b₁(k₂|−kₛ; z₃)·e^{i(q}^{_{g}}^{+q}^{₁}^{)z}^{₁}·e^{-i(q}^{₁}^{+q}^{₂}^{)z}^{₁}·e^{-i(q}^{₂}^{+q}^{ₛ}^{)z}^{₃} (Equation 4)

In one implementation, the computer application may assume that the sources and receivers are at the same depth level, i.e., zₛ=z_{g}. In this manner, the discrete version of the internal multiple estimate equation may be defined as:

$${b}_{3} ( {k}_{g} \vert {k}_{s} ; ω ) = \frac{1}{N} {\sum }_{i} {\sum }_{j} ρ ( {k}_{1 i} , {k}_{2 j} , {k}_{g} , {k}_{s} ; ω ) \\ [ or {b}_{3} ( {k}_{g} \vert {k}_{s} ; ω ) = {\sum }_{i} {\sum }_{j} ρ ( {k}_{1 i} , {k}_{2 j} , {k}_{g} , {k}_{s} ; ω ) Δ {k}_{1 i} Δ {k}_{2 j} ] \qquad ( Equation 6 )$$

where the sum over indices, i and j, runs over the number of sample points, nᵢ and nⱼ in the horizontal wavenumber domain. The total number of sample points is given by N=nᵢnⱼ. The function, ρ(k₁ᵢ,k₂ⱼ,k_{g},kₛ; ω), includes the three depth integrals and has a complex structure involving exponential functions which depends on horizontal wavenumbers k, angular frequency ω, and depth z.

The computer application may then solve the internal multiple estimate equation. However, since the internal multiple estimate equation includes the function, ρ(k₁ᵢ,k₂ⱼ,k_{g},kₛ; ω), which depends on horizontal wavenumbers, conventional integration techniques may be too computationally expensive to use to solve the internal multiple estimate equation. As such, the computer application may solve the internal multiple estimate equation using a quasi-Monte Carlo (QMC) integration over the subset of the regularly sampled seismic data 800. QMC integration techniques are further described in “Monte Carlo Methods” (Hammersley and Handscomb, Wiley, New York, 1964) and “Quasi-Monte Carlo integration over S²×S² for Migration/Inversion” (de Hoop and Spencer, Inverse Problems, 12:219-239, 1996).

The QMC integration may be used to solve the internal multiple estimate equation more quickly than conventional integration techniques. The QMC integration uses sparsely sampled data (i.e., subset of the set regularly sampled seismic data 800), as opposed to regularly sampled data 500, to solve complex equations (e.g., internal multiple estimate equation) involving complex integrals (e.g., horizontal integrals). Additionally, the order of error of the integration result is independent of the dimension of the problem and, hence, Monte Carlo integration methods, e.g. QMC, may be increasingly favorable for higher-dimensional problems.

As mentioned above, the main challenge of evaluating the integral in Equation 1 is the large computational costs involved with evaluating the horizontal integrals. The QMC integration, however, takes advantage of sparsely spaced sample points in a dataset (e.g., the subset of the set regularly sampled seismic data 800) and reduces the number of sample points in a dataset needed to evaluate the horizontal integrals. The QMC integration may then provide a numerically efficient integration scheme for solving the internal multiple estimate equation. Since the computer application solves the internal multiple estimate equation using a QMC integration over the subset of the regularly sampled seismic data 800, the sample points for the QMC integration are not selected randomly. Instead, the computer application's sample points (i.e., the subset of the set regularly sampled seismic data 800) for the QMC integration are selected based the Hammersley points, as described in steps 230-240. By sampling the wavenumbers using Hammersley points, the computer application considerably reduces the number of operations required to solve the internal multiple estimate equation using the QMC integration. The subset of the set of regularly sampled seismic data 800, which is based on the set of Hammersley points 600, also has the advantage of not being regularly sampled. This makes noise appear more random instead of aliased, which would have been the case if the computer application generated the subset of the set of regularly sampled seismic data 500 by picking, e.g. every other data sample in the set of regularly sampled seismic data 500 to obtain a subsampled dataset that is regularly sampled.

By evaluating the summations in Equation 5 using the subset of the set of regularly sampled seismic data 800 as per the QMC integration, the computer application may reduce the two dimensional sums over the horizontal wavenumbers in Equation 5 to a single summation over horizontal wavenumbers provided by the subset of the set of regularly sampled seismic data 800. The single summation over horizontal wavenumbers may be represented as:

$${b}_{3} ( {k}_{g} \vert {k}_{s} ; ω ) = \frac{1}{N} {\sum }_{n = 1}^{N} ρ ( {k}_{1 n} , {k}_{2 n} , {k}_{g} , {k}_{s} ; ω ) . \qquad ( Equation 6 )$$

Accordingly, the computer application may solve Equation 6 to obtain a set of estimated internal multiples for the seismic data received at step 210. In one implementation, the dataset of estimated internal multiples for the seismic data may be in the frequency-wavenumber domain.

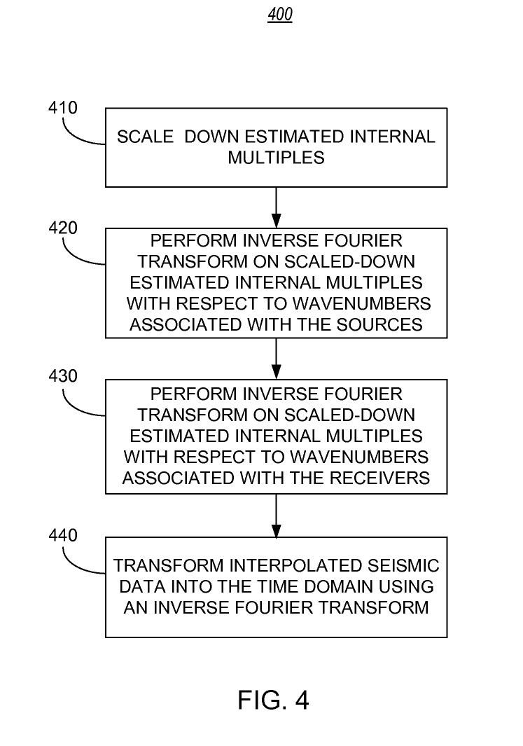

At step 260, the computer application may convert the dataset of estimated internal multiples from the frequency-wavenumber domain to the time-space domain. (See FIG. 4). In order to convert the dataset of estimated internal multiples to the time-space domain, at step 410, the computer application may first scale down the dataset of estimated internal multiples by removing the obliquity factor from the dataset of estimated internal multiples such that:

b₃(k_{g}|kₛ; ω)/−2iqₛ.

The computer application may then transform the scaled-down dataset of estimated internal multiples to the space domain by performing two inverse Fourier transforms. First, at step 420, the computer application may perform an inverse Fourier transform on the scaled-down dataset of estimated internal multiples with respect to the wavenumbers associated with the sources. Then, at step 430, the computer application may perform an inverse Fourier transform on the transformed scaled-down dataset of estimated internal multiples with respect to the wavenumbers associated with the receivers. As a result, the computer application may have transformed the scaled-down dataset of estimated internal multiples from the frequency-wavenumber domain to the frequency-space domain.

At step 440, the computer application may then transform the scaled-down dataset of estimated internal multiples from the frequency-space domain to the time-space domain by performing an inverse Fourier transform on the scaled-down dataset of estimated internal multiples in the frequency-space domain with respect to frequency. Although the above process for transforming the dataset of estimated internal multiples from the frequency-wavenumber domain to the time-space domain has been described in a particular order, it should be noted that the computer application may perform the inverse Fourier transforms described above in any order to obtain the dataset of estimated internal multiples in the time-space domain.

In one implementation, after obtaining the dataset of estimated internal multiples in the time-space domain, the computer application may apply a high-pass filter to the dataset of estimated internal multiples. By applying a high-pass filter to the dataset of estimated internal multiples, the computer application may remove low-frequency noise that may be present in the dataset of estimated internal multiples. Although the dataset of estimated internal multiples has been described as having a high-pass filter applied to it, it should be noted that in other implementations other types of filters may be applied to dataset of estimated internal multiples to remove various types of noise.

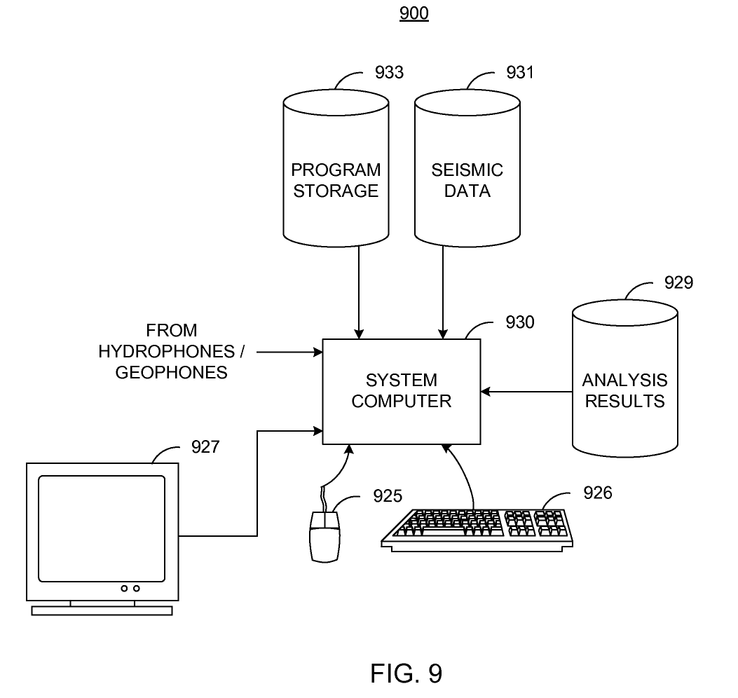

FIG. 9 illustrates a computer network 900 into which implementations of various technologies described herein may be implemented. In one implementation, various techniques for estimating internal multiples in seismic data as described in FIG. 2 may be performed on the computer network 900. The computer network 900 may include a system computer 930, which may be implemented as any conventional personal computer or server. However, it should be understood that implementations of various technologies described herein may be practiced in other computer system configurations, including hypertext transfer protocol (HTTP) servers, hand-held devices, multiprocessor systems, microprocessor-based or programmable consumer electronics, network PCs, minicomputers, mainframe computers, high-performance clusters of computers, co-processing-based systems (GPUs, FPGAs) and the like. In one implementation, the computer application described in method 200 may be stored on the system computer 930.

The system computer 930 may be in communication with disk storage devices 929, 931, and 933, which may be external hard disk storage devices. It is contemplated that disk storage devices 929, 931, and 933 are conventional hard disk drives, and as such, will be implemented by way of a local area network or by remote access. Of course, while disk storage devices 929, 931, and 933 are illustrated as separate devices, a single disk storage device may be used to store any and all of the program instructions, measurement data, and results as desired.

In one implementation, seismic data from the receivers may be stored in disk storage device 931. The system computer 930 may retrieve the appropriate data from the disk storage device 931 to process seismic data according to program instructions that correspond to implementations of various technologies described herein. Seismic data may include pressure and particle velocity data. The program instructions may be written in a computer programming language, such as C++, Java and the like. The program instructions may be stored in a computer-readable memory, such as program disk storage device 933. Such computer-readable media may include computer storage media and communication media.

Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 900.

Communication media may embody computer readable instructions, data structures or other program modules. By way of example, and not limitation, communication media may include wired media such as a wired network or direct-wired connection, and wireless media such as acoustic, RF, infrared and other wireless media. Combinations of the any of the above may also be included within the scope of computer readable media.

In one implementation, the system computer 930 may present output primarily onto graphics display 927. The system computer 930 may store the results of the methods described above on disk storage 929, for later use and further analysis. The keyboard 926 and the pointing device (e.g., a mouse, trackball, or the like) 925 may be provided with the system computer 930 to enable interactive operation.

The system computer 930 may be located at a data center remote from the survey region. The system computer 930 may be in communication with the receivers (either directly or via a recording unit, not shown), to receive signals indicative of the reflected seismic energy. After conventional formatting and other initial processing, these signals may be stored by the system computer 930 as digital data in the disk storage 931 for subsequent retrieval and processing in the manner described above. In one implementation, these signals and data may be sent to the system computer 930 directly from sensors, such as geophones, hydrophones and the like. When receiving data directly from the sensors, the system computer 930 may be described as part of an in-field data processing system. In another implementation, the system computer 930 may process seismic data already stored in the disk storage 931. When processing data stored in the disk storage 931, the system computer 930 may be described as part of a remote data processing center, separate from data acquisition. The system computer 930 may be configured to process data as part of the in-field data processing system, the remote data processing system or a combination thereof. While FIG. 9 illustrates the disk storage 931 as directly connected to the system computer 930, it is also contemplated that the disk storage device 931 may be accessible through a local area network or by remote access. Furthermore, while disk storage devices 929, 931 are illustrated as separate devices for storing input seismic data and analysis results, the disk storage devices 929, 931 may be implemented within a single disk drive (either together with or separately from program disk storage device 933), or in any other conventional manner as will be fully understood by one of skill in the art having reference to this specification.

While the foregoing is directed to implementations of various technologies described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for estimating one or more internal multiples in seismic data, comprising:
selecting a subset from a set of regularly sampled seismic data based on a low-discrepancy point set;
integrating one or more depth integrals of the inverse-scattering internal multiple prediction (ISIMP) algorithm over each data point in the subset; and
integrating a function of the integrated depth integrals using a quasi-Monte Carlo (QMC) integration over the subset, thereby generating an estimate of the internal multiples.

2. The method of claim 1, wherein selecting the subset comprises:
(a) generating the set of regularly sampled seismic data from the seismic data;
(b) generating the low-discrepancy point set from the set of regularly sampled seismic data;
(c) identifying a point in the low-discrepancy point set;
(d) identifying a data point in the set of regularly sampled seismic data that is closest to the point; and
(e) repeating steps (c)-(d) for every point in the low-discrepancy point set.

3. The method of claim 1, wherein the function is based on one or more horizontal wavenumber integrals of the ISIMP algorithm.

4. The method of claim 1, wherein each data point in the regularly sampled seismic data corresponds to two horizontal wavenumbers associated with a co-located source/receiver pair.

5. The method of claim 1, further comprising converting the QMC integrated function from the frequency-wavenumber domain to the time-space domain.

6. The method of claim 1, wherein the low-discrepancy point set is a set of Hammersley points.

7. The method of claim 1, wherein the low-discrepancy point set is a set of Halton points or a set of Sobol sequences.

8. A method for estimating one or more internal multiples in seismic data, comprising:
generating a set of regularly sampled seismic data from the seismic data;
generating a low-discrepancy point set from the set of regularly sampled seismic data;
selecting a subset of the set of regularly sampled seismic data based on the low-discrepancy point set;
integrating one or more depth integrals of the inverse-scattering internal multiple prediction (ISIMP) algorithm over each data point in the subset;
creating a function of the integrated depth integrals based on one or more horizontal wavenumber integrals of the ISIMP algorithm; and
integrating the function using a quasi-Monte Carlo (QMC) integration over the subset to generate an estimate of the internal multiples.

9. The method of claim 8, wherein the seismic data is in the time-space domain.

10. The method of claim 8, wherein generating the set of regularly sampled seismic data comprises:
removing one or more free-surface multiples from the seismic data;
interpolating the seismic data having the removed free-surface multiples into regularly spaced seismic data;
transforming the interpolated seismic data into the frequency-wavenumber domain;
scaling the transformed interpolated seismic data by the obliquity factor; and
applying a constant velocity Stolt migration to the scaled transformed interpolated seismic data.

11. The method of claim 10, wherein transforming the interpolated seismic data into the frequency-wavenumber domain comprises:
performing a Fourier transform on the interpolated seismic data with respect to each receiver in one or more co-located source/receiver pairs, wherein each co-located source/receiver pair is associated with two horizontal wavenumbers and corresponds to a data point in the regularly spaced seismic data;
performing a Fourier transform on the interpolated seismic data with respect to each source in the co-located source/receiver pairs; and
performing a Fourier transform on the interpolated seismic data with respect to time.

12. The method of claim 10, wherein the Stolt migration is uncollapsed.

13. The method of claim 10, wherein the Stolt migration applied scaled transformed interpolated seismic data is in the frequency-wavenumber-pseudo-depth domain.

14. The method of claim 8, wherein selecting the subset comprises:
(a) identifying a point in the low-discrepancy point set;
(b) identifying a data point in the set of regularly sampled seismic data that is closest to the point; and
(c) repeating steps (a)-(b) for every point in the low-discrepancy point set.

15. The method of claim 8, further comprising converting the QMC integrated function into the time-space domain.

16. The method of claim 15, wherein converting the QMC integrated function comprises:
scaling down the QMC integrated function by the obliquity factor;
performing an inverse Fourier transform on the scaled-down QMC integrated function with respect to two horizontal wavenumbers associated with each receiver in one or more co-located source/receiver pairs, wherein each co-located source/receiver pair corresponds to a data point in the regularly spaced seismic data;
performing an inverse Fourier transform one the scaled-down QMC integrated function with respect to two horizontal wavenumbers associated with each source in the co-located source/receiver pairs; and
performing an inverse Fourier transform on the interpolated seismic data with respect to frequency.

17. A method for processing seismic data, comprising:
generating a set of regularly sampled seismic data from the seismic data;
selecting a subset from the set of regularly sampled seismic data based on a low-discrepancy point set;
integrating one or more depth integrals of the inverse-scattering internal multiple prediction (ISIMP) algorithm over each data point in the set of regularly sampled seismic data;
integrating a function of the integrated depth integrals using a quasi-Monte Carlo (QMC) integration over the subset, thereby generating an estimate of the internal multiples; and
removing the estimate of internal multiples from the seismic data.

18. The method of claim 17, wherein the seismic data is in the time-space domain.

19. The method of claim 17, wherein generating the set of regularly sampled seismic data comprises:
removing one or more free-surface multiples from the seismic data;
interpolating the seismic data having the removed free-surface multiples into regularly spaced seismic data;
transforming the interpolated seismic data into the frequency-wavenumber domain;
scaling the transformed interpolated seismic data by the obliquity factor; and
applying a constant velocity Stolt migration to the scaled transformed interpolated seismic data.

20. The method of claim 19, wherein each data point in the regularly spaced seismic data corresponds to two horizontal wavenumbers associated with a co-located source/receiver pair.
